(19) United States
(12) Patent Application Publication
(10) Pub. No.: US 2004/0265502 A1
(43) Pub. Date: Dec. 30, 2004

(54) Autodeposition process

(76) Inventor: James B. Williams, Erie, PA (US)

Correspondence Address: LORD CORPORATION, PATENT & LEGAL SERVICES, 111 LORD DRIVE, CARY, NC, 27512, US

(21) Appl. No.: 10/880,024

(22) Filed: Jun. 28, 2004

Related U.S. Application Data
(60) Provisional application No. 60/483,868, filed on Jun. 27, 2003.

(51) Int. Cl. B05D 1/18

(52) U.S. Cl. 427/443.1

(57) ABSTRACT

An autodeposition process is disclosed which eliminates conventional wet pretreatment steps and comprises a non-contact, cleaning step for the metal part in an electromagnetic field, volatilizing contaminants and forming an in-situ surface oxide (Fe₂O₃ and/or Fe₃O₄) pigment layer on the part, cooling the part, autodepositing a coating on the entire surface oxide layer, followed by dehydration and/or further curing. Any inductive-heat induced oxide pigment layer of from 2- about 500 nm is suitable for the entire oxide layer

### FIELD OF THE INVENTION

The invention is directed to methods and products from methods entailing metal corrosion coatings based on autodeposition. Coating formation by this type of composition is achieved through the chemical activity of the coating composition on the metal surface: Metal ions are released by etching and the local ion concentration at the metal surface is high enough to interact with the resin particles to cause their deposition on the metal surface. Thus, unlike electrodeposition processes, autodepositing coating compositions are able to efficiently form a resin coating on metal surfaces without the use of an external source of electricity.

### BACKGROUND OF THE INVENTION

Significant problems can arise in autodeposition due to variability in the metal part surface. Metalworking typically entails either cutting or machining, which includes drilling, turning, grinding, honing, lapping, milling, and broaching; or deformation to change shape without melting or cutting. Deformation includes rolling, drawing, extrusion, forging, stamping, and spinning. In both cutting and forming operations, metalworking fluids are essential to control wear and frictional heating from metal-to-metal contact.

In metal parts forming operations such as rod, band and wire drawing, various surface treatments are applied to the workpiece part. In high speed cutting where cooling is a principle requirement, water-base fluids are commonly used which contain 5% or less organic lubricants, rust protectants, wetting aids. Also used are straight oils containing sulfur compounds, petroleum or synthetic oil fortified with additives, polyol esters for rolling steel, and poly(alkylene glycol)s and polybutenes as dispersions in solvents for cold rolling. Semifluid pastes are applied in cold pressing sheet metal, and water or oil dispersions of graphite and other solid lubricants are used as spray lubricants in hot forging. Hereinafter, metal parts containing accumulated surface contaminants, and/or rust, or in a state of partial cleaning from pretreatments are referred to as contaminated parts or mill spec parts.

Metal surface preparation steps can include descaling by mechanical or chemical means, e.g., pickling. Oil and related contaminants must be removed by detergent, acids, alkali or solvent washing/degreasing. In the use of hot alkaline treatments and detergent washings, the last trace of detergent must be rinsed off before drying preparatory to coating. The conventional metal surface wet pretreatment steps preparatory to autodeposition coating, in general order, can include alkaline presoaking, alkaline rinsing, acid pickling, acid rinse, spray rinsing, final rinsing and drying, prior to autodepositing the corrosion coating.

The cost of completing the conventional pretreatment steps of mill spec parts significantly impacts the economics of metal coatings Even with extensive series of dip operations, ultrasonic cleaning, rinsing and drying variability of autodeposition coating thickness, adhesion and corrosion resistance is impacted by the variable surface conditions of mill spec parts, from part-to-part and lot-to-lot, after conventional pretreatments.

Conventional steel corrosion protection pretreatments entail phosphate conversion pretreatments. This method is used extensively for steel parts. U.S. Pat. No. 5,011,551 illustrates a conventional metal conversion treatment solution that includes an aliphatic alcohol, phosphoric acid, an alkali nitrate, tannic acid and zinc nitrate. U.S. Pat. No. 4,293,349 relates to a steel surface protective coating composition that includes pyrogallic acid glucoside, phosphoric acid, phosphates of bivalent transition metals such as Zn or Mn, Zn or Mn nitrate, and, optionally, formaldehyde. Phosphatizing alone is insufficient as a total pretreatment and supplements other aforementioned treatments. Phosphatizing is itself a multistep process that is capital intensive, requires close monitoring and can generate significant amounts of waste sludge. In addition, phosphatizing requires chemical oxidative accelerators that promote corrosion, which must be removed by multiple rinsing steps. Conventional inorganic phosphate conversion coatings are also very brittle and thus can fracture. Hexavalent chromate conversion treatments have been used when salt exposure is possible but there has been increasing use of chromate-free treatments because of toxic hazards associated with these materials.

Extensive pretreatments of mill spec metal parts are required prior to application of corrosion coatings based on aqueous autodepositable materials. A typical autodeposition coating generally comprises an aqueous solution of an acid, an oxidizing agent and a dispersed resin. Immersion of an electrochemically active metallic surface in an autodeposition composition produces a deposition in the presence of multivalent ions released from the metal surface. The general principles and advantages of autodeposition are disclosed in patents assigned to Parker Amchem, Henkel, and Lord (see, for example, U.S. Pat. Nos. 4,414,350; 4,994,521; 5,427,863; 5,061,523, 5,500,460, 6,130,289, 6,383,307, 6,476,119, and 6,251,687).

Often parts to be coated containing localized random patterns of rust due to storage at ambient conditions. Phosphatizing may not result in a uniform surface for coating due to localized differences in the extent of corrosion. The variable oxide content critically impacts the rate of autodeposition and hence the coating thickness, adhesion and variability in the corrosion performance of autodeposition coatings.

There is an ongoing need for improving autodeposition as a coating method. It would be desirable to provide a semi-automated Autodeposition metal coating processes are increased throughput, improved uniformity and long term corrosion resistance, lower energy requirements, reduced chemical waste, and lower capital and space requirements. An environmentally acceptable, high throughput, environmentally preferred semi-automated metal treatment process which eliminates conventional pretreatment steps with superior uniformity of coating, regardless of variability in surface contamination, variable oxidation levels, or pretreatment methods would be of considerable industrial importance.

An autodeposition process, which obviates many of these variables, eliminates any or all wet pretreatments, with higher throughput; improved coating uniformity with less capital cost has been devised.

### SUMMARY OF THE INVENTION

In accordance with the invention, an autodeposition process is provided, absent any one or more conventional wet pretreatment steps and comprises a non-contact, cleaning step for the metal part in an electromagnetic field, volatilizing contaminants and forming an in-situ surface oxide (Fe₂O₃ and/or Fe₃O₄) pigment layer on the part, cooling the part, autodepositing a coating on the entire surface oxide layer, followed by dehydration and/or further curing. Any inductive-heat induced oxide pigment layer of from 2- about 500 nm is suitable for the entire oxide layer. The preferred surface is a blue oxide characterized by a 100-300 nm thick oxide layer and a blue-black color. A yellow color is obtainable typically where the oxide layer is from 2-20 nm thick.

Although decomposition carbon and other trace residues can remain at the oxidized surface, surprising improvements in the uniformity of autodeposition are provided having acceptable corrosion resistance that enables trouble-free automation programming as part of the process. The process can be coupled to any aqueous autodeposition coating method to replace some or all wet pre-treating steps.

In a variant of the basic process, a steel part containing a random pattern of environmental rust is subjected to an induction surface oxidizing step to form an entire induction oxide layer followed by autodepositing a surface coating, optional rinsing, dehydration or curing.

In an alternative process, the induction oxidation step is conducted in an oxygen-free atmosphere, prior to autodepositing a coating, optional rinsing, dehydration and/or curing.

In a semi automated coating process embodiment for autodepositing a coating on mil spec parts, an apparatus comprising an induction heating power supply coupled to an induction coil, a computer controlled electromechanical articulated robot arm equipped with a part or fixture engager, at least one autodeposition dip tank, and a means for dehydrating and/or curing the parts, the process comprises directing the robot arm to the part location, engaging the part or fixture of parts, passing the part or fixture in close proximity to the induction coil for a predetermined time, at a predetermined induction power setting, moving the part or fixture over the dip tank and immersing the part or fixture in an aqueous Autodeposition fluid comprising

The autodeposition coatings can be single of multiple layers. Coatings or adhesives can be allied to the autodeposition coatings. In some embodiments, a first autodeposition corrosion protectant layer is coated on the oxide layer of the part, and in another coating step, an autodeposited adhesive is applied, such as disclosed in copending application Ser. No. 10/304,219, incorporated herein by reference. The surface oxide pigment layer is integrally attached to the metal part and provides a surprising level of adhesion on which autodeposition occurs. Subsequent coatings such as primers and adhesives on the autodeposition-coated metal surface provides long-term corrosion resistance. Since this treatment requires only a minimum number of coatings—typically from one to three coatings.

### DETAILED DESCRIPTION

The materials of construction of the metal parts coated by the process are any of the steels conventionally selected. The carbon content of alloys is not critical, but determines the selection of induction heating conditions, e.g., power setting and dwell time when the part is in proximity to the induction coil. These conditions are readily predetermined for each part on a simple trial and error basis. The mild steels are heated more rapidly than stainless steel. The process is especially advantageous in coating a wide variety of bushings, sleeves, shims, rings, bands, rotors, rods, wires, tubeforms (cylinders), gaskets, seals, and the like.

“Electrochemically active metals” means iron and all metals and alloys more active than hydrogen in the electromotive series. Examples of electrochemically active metal surfaces include zinc, iron, aluminum, steel, stainless steel. Specific examples include cold-rolled, polished, pickled, hot-rolled, phosphatized, and galvanized steel.

“Primer” means a liquid composition applied to a surface as an undercoat beneath a subsequently applied covercoat. The covercoat can be an adhesive and the primer/adhesive covercoat forms an adhesive system for bonding two parts together.

“Coating” means a liquid composition applied to a surface by autodeposition to form a protective and/or aesthetically pleasing coating on the surface.

“Phenolic compound” means a natural or synthetic, simple or complex mixture, monomer, oligomer or resin that includes at least one or multiple hydroxy functional groups attached to a carbon atom of an aromatic ring, as materials for forming phenolic autodepositable coatings. Illustrative phenolic compounds include phenol, alkylated phenols, alkoxy-phenols, chloro-phenols, and multi-hydroxy phenols, and hydroxy-substituted multi-ring aromatics, e.g. phenolic novolak, and phenolic resoles. Illustrative phenolic compounds include methylphenol (cresol), dimethylphenol (xylenol), 2-ethylphenol, pentylphenol tert-butyl phenol, 1,3-benzenediol (resorcinol), 1,2-benzenediol (pyrocatechol), 1,4-benzenediol (hydroquinone), 1,2,3-benzenetriol (pyrogallol), 1,3,5-benzenetriol and 4-tert-butyl-1,2-benzenediol (tert-butyl catechol). Illustrative hydroxy-substituted multi-ring aromatics include 4,4′-isopropylidenebisphenol (bisphenol A), 4,4′methylidenebisphenol (bisphenol F) and naphthol.

“Aldehyde compound” means a compound having the generic formula RCHO. Illustrative aldehyde compounds include formaldehyde, acetaldehyde, propionaldehyde, n-butylaldehyde, n-valeraldehyde, caproaldehyde, heptaldehyde and other straight-chain aldehydes having up to 8 carbon atoms, as well as compounds that decompose to formaldehyde such as paraformaldehyde, trioxane, furfural, hexamethylenetriamine, acetals that liberate formaldehyde on heating, and benzaldehyde. Naturally occurring phenolic compounds include tannins.

“Phenolic resin” means the reaction product of a phenolic compound with an aldehyde compound. The molar ratio of the aldehyde compound (for example, formaldehyde) reacted with the phenolic compound is referred to herein as the “F/P ratio”. The F/P ratio is calculated on a per hydroxy-substituted aromatic ring basis.

“Phenolic resin precursor” means a phenolic compound that is reacted with a modifying agent to produce a dilutable, acid stable phenolic dispersion.

“Autodeposition” means the application of an aqueous composition to an electrochemically active metal part whereby acid provided in the aqueous coating reacts at the metal surface to release multivalent metal ions (for example, ferric and/or ferrous ions in the case of steel) that leads to a time-dependant deposition of a wet gel from the aqueous composition on the metal surface and may be self-limiting, i.e., the rate of deposition may decrease over time. Autodeposition leaves generally uniform, gelatinous, acidic wet film, which may or may not be rinsable, after withdrawal of the autodeposited metal part. Drying and/or curing results in metal conversion by the further action of acid on the metal surface (for example, metal phosphate in the case of phosphoric acid). The rate of thickness and areal density increase, however, decreases rapidly with immersion time.

“Induction cleaning” and “induction heating” refer to a device that supplies an alternating current to a field coil generating an electromagnetic field. The field induces eddy currents in the part material that flow against its resistivity and generates heat. The frequency of the alternating current controls the depth to which it penetrates in the part surface. Low frequencies are adaptive to heating relatively thicker parts. Higher frequencies are adaptive for smaller parts or shallow penetration. Induction heating units comprise an RF power supply for induction heating and commercially available units generally can range from 3 to 20 kW, depending on material and application requirements. Power levels and heating times are preset and matched to the characteristics of the part and the design of the induction coil.

Surface temperature of about 850° F. (454° C.) are high enough to generate the thicker blue oxide layers in as little as a few seconds. Dwell in the EM field, once the peak temperature is reached, does not appear to appreciably enhance the oxide layer, especially in parts with surface area-volume ratios of 2 and higher. The field coils are typically hollow copper tubing with circulating cooling water and vary considerably in shape according to the part geometry. Heat is generated at the surface of the part. One power supply unit can be adapted to supply several field coils. In one embodiment, one coil at one power setting used for forming the entire surface oxide layer on the part surface, and another coil at another location is preset for dehydrating the wet autodeposition coating. This second coil or a further induction coil can be employed in a presetting for final curing of the coatings.

Parts can be individually treated, or several parts arranged on a fixture. The electromechanical coating device grasps a part or engages with the fixture. The path of the part of fixture is readily pre-programmed for passing in proximity to the EM filed around the coil. The field coil is readily shaped to direct an optimum EM filed in relation to the pre-programmed movements of the parts in proximity therewith.

The preferred semi-automated process entails oxide formation, autodeposition and drying/curing using a microprocessor controlled automated electromechanical device, preferably a robotic arm, which is articulative through an extensive array of motions, actions and/or travel paths.

“Articulative electromechanical device” means a mechanical device, which is operatively connected to and controllable by a microprocessor such as a computer or central processing unit. The articulative electromechanical device is programmed as known in the art to execute a series of recognizable commands to perform various facets of the method of the invention. The term “articulate” is defined as, but not limited to, motions such as movement of at least a portion of the electromechanical device from a first point to a second point, rotations, accelerations at different rates, spring movements, gyrations, moving in an arc, moving up and down, twisting in a defined space, moving in an arc with simultaneous rotation, pivoting about a pivot point and the like, or a combination and/or sequences thereof. Such electromechanical devices are well known and commercially available from suppliers such as CRS Robotics of Burlington, Ontario, Canada; Kawasaki Robotics of Wixom, Mich.; Toshiba of Elk Grove Village, Ill.; and Stäubl Unimation of Duncan, S.C. A preferred electromechanical device is a robotic arm from CRS Robotics as model F3. A further discussion of the apparatus preferred for use in this invention is disclosed in copending U.S. application Ser. No. 10/609,116 filed concurrently.

The electromechanical device comprises a part grasping element which allows for precise control and movement of the part. The part grasping element has any number of forms, which are at least somewhat dependent on the shape, size, dimensions, etc. of the part. Suitable grasping elements are grasping means such as “fingers” or “hands”, magnets, suction elements, pins, hooks, or the like. The method of the present invention is preferably practiced in a relatively compact area.

In one method of the present invention, the microprocessor controlled articulative electromechanical device is employed to guide a part through the oxide formation step, autodeposition coating step, and dehydration and/or curing steps. In one embodiment of the method, a part is retrieved from a defined, registered location by the electromechanical device, more specifically the grasping element thereof. The part is moved to close proximity within the EM field of the field induction coil, held or moved through the EM filed for time sufficient for the entire oxide layer to be formed; then advanced to an autodeposition tank location and immersed in a first autodeposition composition for a predetermined immersion time, followed by withdrawal ad a predetermined withdrawal rate. After withdrawal, the wet-coated part is preferably moved in a predetermined articulated path to remove any air bubbles or entrapped air, and allow lower drip edges to be spread so as to prevent excessive film build. Then, the part is withdrawn from the bath after a predetermined time at a predetermined rate and orientation to remove or drain any excess or trapped coating. The autodeposited part is optionally articulated after withdrawal from the bath. The articulated motion performed on the coated part prevents drip lines and provides a controlled coating thickness. The coated part is transferred by the electromechanical device to a drying device for a predetermined period of time. Afterwards, the coated part is optionally transferred by the electromechanical device to a baking device for further curing or drying. The electromechanical device then transfers the coated part into a part receiving area for shipping, further processing, etc.

In a further embodiment, before the coated part having first autodeposition composition thereon is cured, an additional second autodeposition composition is applied. In this embodiment, the electromechanical device transfers the coated part to a second autodeposition tank wherein the coated part is immersed and preferably articulated in a second composition, which is preferably different than the first composition. The coated part is removed from the second autodeposition composition and articulated through a range of motions as stated above, which is different from or the same as the first articulation motion. The coated part is transferred by the electromechanical device to a device for drying. Afterwards, the coated part is optionally transferred by the electromechanical device to a baking device for further curing or drying. The electromechanical device then transfers the coated part into a part receiving area for shipping, further processing, etc.

The method of the present invention utilizing the electromechanical device maximizes throughput of articles in an autodeposition process and hence reduces manufacturing costs and/or time. The autodeposition method utilizing an electromechanical device, such as robotic arm, is particularly useful to provide a metal surface of a part with corrosion protection and/or a primer for a further use, such as in rubber-to-metal bonding process. Further, the process is performed with a rinsing step(s) if desired, as typically performed in prior art processes. The present invention offers great transfer efficiency of wet chemistry. Moreover, rapid turnover of small baths is possible, allowing the use of compositions with short shelf lives, especially compositions comprising components that are not stable in each other for very long periods of time. Precise control of dry film thickness on a part is advantageously achieved.

Autodepositable coating compositions that are employed in the present process are known and widely available. The organic resins to be autodeposited on the entire oxide surfaces may include a variety of resin materials in emulsion (latex) or dispersion form as known from numerous publications provided these are anionic-stabilized. Resins based on epoxy resins such as glycidyl ethers of polyhydric phenols (e.g., bisphenol A) are suitable for use in the present invention. The epoxy resin emulsions, in addition to one or more epoxy resins, may contain cross-linkers, curatives, emulsifiers, coalescing solvents, accelerator components, and the like. Such epoxy resin-based autodeposition coating systems are described, for example, in U.S. Pat. Nos. 4,233,197; 4,180,603; 4,289,826; and 5,500,460 and app. Ser. No. 60/002,782, the teachings of each of which are incorporated herein by reference in their entirety. Internally stabilized latexes having sulfonic acid functional co-monomers are preferably used. Blends of epoxy resins and polyacrylate resins containing carboxylic and/or sulfonic acid groups are also suitable. Blends of phenolic dispersions and film forming latexes are more preferred. Other suitable autodepositable anionic dispersions envisioned are polyethylene (Primacor®), polyacrylates, nitrile butadiene coplymers, styrene-butadiene copolymers, urethanes, polyesters, vinyl chloride homo- and copolymers, vinylidene chloride homo- and copolymers and the like. See also U.S. Pat. Nos. 4,414,350; 4,994,521; 5,427,863; 5,061,523; and 5,500,460 herein fully incorporated by reference. The dilute aqueous dispersion is in a quasi-stable colloidal dispersed state by anionic groups (e.g., sulfonate, carboxylate, phosphate, etc.) bound to the phenolic resin. In alternatives, the ionic groups are present as part of an associated anionic dispersant, such as known polyacrylates. Quasi-stable, means colloidal stability in the bulk of the liquid material and instability at the interface of activated metal surfaces where localized high concentrations of divalent metal ions appear on contact of the metal and activator/accelerator. Commercial products are available under the AUTOPHORETIC and MetalJacket™ Series.

The typical autodeposition coating liquids comprise water, resin solids dispersed in the aqueous medium, and an activator. For example, the aqueous autodeposition solution in one commercial embodiment contains 3-7 percent solids of a latex (polyvinylidene chloride or acrylic) or blend of phenolic and film forming latex polymer, carbon black, ferric fluoride and a low concentration of hydrofluoric acid, or phosphoric acid activator to provide a solution pH of 1.5-3.0. The part having an entire oxide layer formed in the cleaning step is immersed in the autodeposition solution for a predetermined time of from a few seconds to up about two minutes, optionally rinsed, and dried/cured. This first coating can be optionally overcoated after dehydrating and prior to full curing.

The most preferred autodeposition compositions for the coating baths used according to the present invention comprise aqueous phenolic dispersions disclosed in U.S. Pat. Nos. 6,130,289, 6,383,307, 6,476,119, and copending application Ser. No. Ser. No 10/138,957, the teachings of which are incorporated herein by reference. In a preferred embodiment a first autodeposition coating is applied directly to a part having an entirely blue oxidized metal surface. The part is immersed in a bath at preferably 4-8 wt. % solids content, aqueous dispersed phenolic novolak and a resole of molecular weight in the range of water solubility or dispersibility. The preferred manner of adapting phenolic compounds as dispersions for use in an autodepositable coating agent entails incorporating into the phenolic compound with at least one ionizable sulfur, and/or phosphorous, and/or activated carboxylic acid group, which is sufficiently ionized to aid in providing colloidal stability in the dispersion at an acidic pH (1-7), especially in a pH of 1-5, incurred in the autodeposition process.

A more detailed disclosure of modified phenolic dispersions is in co-pending application Ser. No. Ser. No. 10/138,957. A general depiction of bound ionic modifying agents for aqueous dispersed phenolic compounds is represented in the following figures showing hydrocarbyl moieties where “ionic” is the ionic group specified herein, “link” is a group that covalently bonds to a phenolic, and “x” denotes an oxygen-, nitrogen-, sulfur-, or phosphorous-containing group as a substituent in A or as an intervening group in B:

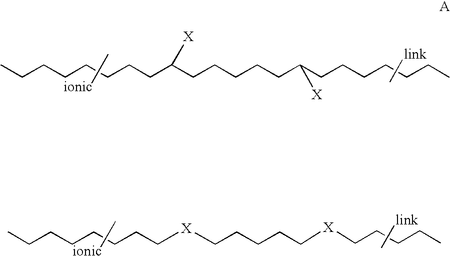

Not depicted above is the included alternative where both intervening and substituents groups are present in the hydrocarbyl moiety. Representative X groups are O, S, N, acyl-N, tertiary N-alkyl, ether, thioether, sulfoxide, sulfone, phosphine, phosphine oxide, ureido, alkylated ureido, amide, and alkylated amide. Intervening X groups can be repeating units, e.g. polyethers segments.

The hydrocarbyl moiety comprises either (i) a C₁-C₂₀ linear or branched, substituted and unsubstituted aliphatic hydrocarbon, (ii) C₇-C preferably C7-C₂ aliphatic hydrocarbons, (ii) C₆-C₁₈ mononuclear-, (iii) C₁₂-C₃₀ multinuclear- and C₁₀-C₃₀ fused aromatic compounds. Examples of fused aromatic hydrocarbyl moieties as modifying agents are DHNS, and sultam acid, i.e., 1,8-naphthosultam-2,4-disulfonic acid—C₁₀H₄(SO₃H)₂NHSO₂. The hydrocarbyl moiety can include heteroaromatic groups. The modified phenolic dispersion can be obtained by initially reacting or mixing a phenolic resin precursor and a modifying agent via a condensation reaction between the phenolic resin precursor and the modifying agent.

The most preferred phenolic resole contains one or more sulfonomethyl, phosphonomethyl, groups, and one or more methylol groups attached to the same aromatic ring. The pendant methylol groups are deactivated and this resole forms a stable acidic dispersion and will cure on application of heat. The modified phenolic novolak, or resole, or combinations thereof, or each or both in combination with other phenolic resins are preferred for the autodeposition process.

The phenolic dispersions are preferably blended with one or more film forming flexibilizers and/or covercoating resins include vinylidene chloride latexes available From DOW Chemical, Imperial Chemical Industries, and Morton Chemical. Preferred film forming flexibilizers include halogenated polyolefins, chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of a-haloacrylonitriles and 2,3-dichloro-1,3-butadiene, chlorinated poly(vinyl chloride) and the like including mixtures of such halogen-containing film formers. A specific example of a film forming flexibilizer is chloroprene-styrene sulfonic acid-2,3-dichlorobutadiene latex. The preferred film forming flexibilizers are latexes of chlorosulfonated polyethylene, poly(2,3-dichloro-1,3-butadiene), brominated poly(2,3-dichloro-1,3-butadiene), copolymers of a-haloacrylonitriles and 2,3-dichloro-1,3-butadiene.

Butadiene latices are particularly preferred as the flexibilizer, with nitrile butadiene copolymers being most preferred. Methods for making butadiene latices are well known and are described, for example, in U.S. Pat. Nos. 4,054,547 and 3,920,600, both incorporated herein by reference. In addition, U.S. Pat. Nos. 5,200,459; 5,300,555; and 5,496,884 disclose emulsion polymerization of butadiene monomers in the presence of polyvinyl alcohol and a co-solvent such as an organic alcohol or a glycol. Nitrile lattices are commercially available from Noveon (formerly BFGoodrich Specialty Chemicals).

The acid is any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition.

It is preferred to utilize an oxidizer/accelerator in the first autodeposited coating. These include well-known nitro compounds, a nitroso compounds, oxime compounds, a nitrate compounds, or a similar materials. A mixture of control agents may be used. Organic nitro compounds are the preferred control agents. The preferred organic nitro compounds contain a nitro group (—NO₂) bonded to an organic moiety. Preferably, the organic nitro compound is water-soluble or, if water insoluble, capable of being dispersed in water. Illustrative organic nitro compounds include nitroguanidine; aromatic nitrosulfonates such as nitro or dinitrobenzenesulfonate and the salts thereof such as sodium, potassium, amine or any monovalent metal ion (particularly the sodium salt of 3,5-dinitrobenzenesulfonate); Naphthol Yellow S; and picric acid (also known as trinitrophenol). Especially preferred for commercial availability and regulatory reasons is a mixture of nitroguanidine and sodium nitrobenzenesulfonate. The amount of control agent(s) in the first autodepositable aqueous dispersion may vary, particularly depending upon the amount of any acid present. Preferably, the amount is up to 20 weight %, more preferably up to 10 weight %, and most preferably 2 to 5 weight %, based on the total amount of non-volatile ingredients in the autodepositable aqueous dispersion. According to a preferred embodiment, in a mixture of oxidizer/accelerators, the weight ratio of nitroguanidine to sodium nitrobenzenesulfonate should range from 1:10 to 5:1.

### EXAMPLE 1

### Induction Oxidation and Induction Dehydration of Parts Coated with Autodeposition Coatings

Using steel bushings, a blue oxide layer 200 nm thick was formed by induction heating using a 3 Kw NOVASTAR model 3L, from Ameritherm, Inc., Scottsdale, N.Y. The solid-state induction power supply was operated with a remote heat station. Bands made Cold rolled steel (CRS) bands, which contained mill fluid residues. The peak surface temperature of the bands in the induction stage exceeded 750° F. (398° C.), after cooling the bands were each coated with an autodepositable coating in a dip-application. Several autodepositable coatings from Lord Corporation were used in forming autodeposited coatings. MetalJacket 1399, 1200, and Metal Treatment 1399 with autodepositable adhesive 3100 were evaluated. The same induction coil was used for both cleaning and drying, but at different predetermined settings as follows:

Induction Cleaning Parameters

Bushing Inners: 20 seconds @ 65% voltage.

Bushing Outers: 24 seconds @ 65% voltage

The oxidized bushings were immersed in each autodeposition coating bath, and the wet films were dried using the field coil. The induction drying parameters were:

Bushing Inners: 40 seconds @ 23% voltage

Bushing Outers: 50 seconds @ 23% voltage.

The induction Adhesive 3100 Drying Parameters were:

Bushing Inners: 30 seconds @ 23% voltage

Bushing Outers: 30 seconds @ 23% voltage

Corrosion Resistance Testing.

The autodeposition-coated bushings were placed in a salt fog chamber and observed after time. The level of corrosion resistance in the bushing treated by the process of the invention had comparable corrosion levels to that obtained in a convention process, which included wet pretreatments. Slight blistering was observed in the Example bushings after 72 hours in the salt fog chamber. For comparison, uncoated bushings tested in the salt fog chamber showed distinct areas where heavy corrosion had occurred as well as distinct areas where corrosion has not occurred. Salt fog chamber testing was extended from 96 hours to 120 hours based on evidence of blister formation in the MT1399/AD3100 system; blistering under the Adhesive 3100 initiated after 96 hours; early signs of blistering were evident at 120 hours.

### EXAMPLE 2

### Audeposition of Variably Oxidized Mill Spec Parts

This example demonstrates the effectiveness of the process for preparing an unequally oxidized mill spec part and autodepositing a coating. Ring bands containing scaly red rust were converted to an entire oxide layer using the induction unit of example 1. Each ring band was placed in the EM field for 20 sec at 90% power voltage setting. A blue oxide layer was formed, even though some staining and discoloration was still discernable at the original heavy rust areas. Complete removal of the original rust was not required to achieve uniform autodeposition film build. Whereas, without forming the entire oxide layer, autodeposition coating was non-uniform, with excessive film build in the more severely corroded spots.

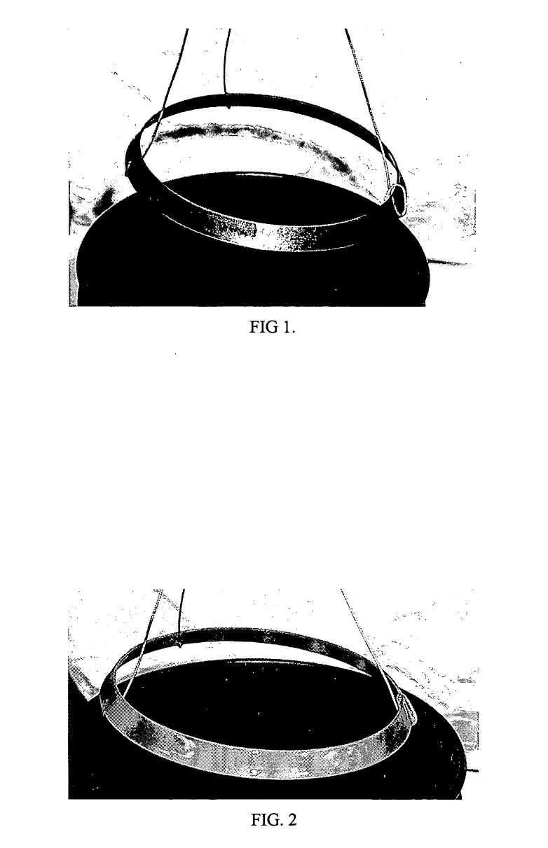

FIG. 1 illustrates the ring band after formation of the entire oxide surface just before autodeposition coating.

FIG. 2 illustrates the wet autodeposited film of MetalJacket™ 1300 on the ring band.

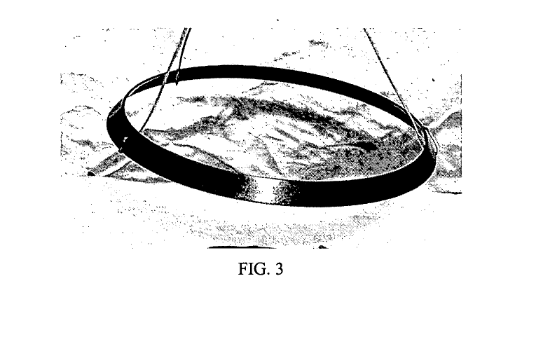

FIG. 3 illustrates the dried autodeposited film on the ring band.

We claim:

1. A method for autodepositing a mill spec metal part, comprising retrieving said part, locating said part in proximity to an electromagnetic field, forming an entire surface oxide,
retrieving a part with a grasping element of an articulative electromechanical device;
bringing said substrate into contact with a first autodepositing composition for a predetermined period of time forming a first film on a surface of said substrate, and dehydrating the film.

2. The process of claim 1 further comprising articulating said substrate either in said first composition, or a combination thereof, after contact with said first composition for a predetermined period of time, with said electromechanical device.

3. A method according to claim 1, wherein said first film has a dry film thickness of 2.5 to 25.4 micrometers.

4. A method according to claim 1, wherein said contact with said first composition is from 1 to 180 seconds.

5. A method according to claim 3, wherein said articulating step is performed while said part is in contact with said first autodepositing composition and after contact with said first autodepositing composition.

6. A method according to claim 2, further comprising the step of curing said substrate in a drying device after said first autodeposited film has been formed.

7. A method according to claim 1, further comprising the steps of bringing said entire surface oxidized part into contact with a second autodepositing composition for a predetermined period of time to form a second film on said substrate, and articulating said substrate either in said second composition, or after contact with said second composition, or a combination thereof for a predetermined period of time, with said electromechanical device.

8. A method according to claim 6, wherein said second film has a dry film thickness of 2.5 to 25.4 micrometers.

9. A method according to claim 7, wherein said first autodepositing composition is a metal treatment, or an adhesive composition, and wherein said second autodepositing composition is a primer composition or an adhesive overcoat composition.

10. A method according to claim 2, wherein said first composition comprises a) a metal treatment comprising an acid, and a phenolic resin, or b) an adhesive composition comprising a flexibilizer, and an acid.

11. A method according to claim 8, wherein said second composition is a) a primer comprising a phenolic resin and a flexibilizer, or b) an adhesive overcoat composition comprising a flexibilizer, and phenolic resin and a crosslinker.

12. A method according to claim 8, wherein part is dried in a drying device after coating with each said first and second compositions, wherein said drying utilizes infra-red radiation, radio frequency energy, convection currents, air currents, heated zones, forced air, induction, or a combination thereof, and wherein said bringing of said substrate into contact comprises immersion.

13. A method according to claim 3, wherein bringing said substrate into contact comprises immersion, and wherein said electromechanical device comprises a microprocessor, which operatively controls a robot arm.

14. A method according to claim 12, wherein said immersion ranges from 3 to 60 seconds.

15. A method according to claim 13, wherein said articulation is performed from 20% to 90% of immersion time.

16. A method according to claim 4, wherein said electromechanical device comprises a robot arm, and where said grasping element is a grasping means, pin, hook, hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.

17. A method according to claim 11, wherein said electromechanical device comprises a robot arm, and where said grasping element is a grasping means, pin, hook, hanger, expandable means, compression grip, insertion grip, suction means, magnet, or a combination thereof, wherein said substrate displaces at least 0.25% of a volume of the first autodepositing composition in a tank, and wherein said first composition has a bath turnover of about 1 hour to about 5 days.
